(19) United States
(12) Patent Application Publication
(10) Pub. No.: US 2023/0182045 A1
(43) Pub. Date: Jun. 15, 2023

(54) LIQUID FILTER UNIT WITH VERTICALLY ARRANGED FILTERS, AND METHOD OF OPERATING THEREOF

(71) Applicant: ENTEGRIS, INC., Billerica, MA (US)

(72) Inventors: Siddarth Sampath, Tyngsboro, MA (US); Ashutosh Shrikant Bhabhe, Zug (CH); Christopher Paul Barck, Westford, MA (US); Hayden Lincicome, Waltham, MA (US)

(21) Appl. No.: 18/077,813

(22) Filed: Dec. 8, 2022

Related U.S. Application Data
(60) Provisional application No. 63/289,482, filed on Dec. 14, 2021.

(51) Int. Cl. B01D 29/58; B01D 29/15; B01D 29/23; B01D 24/00; B01D 24/10; B01D 63/06

(52) U.S. Cl. CPC B01D 29/58; B01D 29/15; B01D 29/23; B01D 24/008; B01D 24/10; B01D 63/06; B01D 2201/291; B01D 2313/21; B01D 2313/08

(57) ABSTRACT

A filter unit for filtering liquid includes a housing with an inlet and an outlet, a first filter and a second filter disposed in the housing, and a liquid flow path extending from the inlet to the outlet. The liquid flow path directs the liquid one of radially inward and radially outward through a first filter media of the first filter and the other one of radially and directs the liquid the other one of radially inward and radially outward through a second filter media of the second filter. A method of filtering a liquid within a filter unit includes passing the liquid one of radially inward and radially outward through a first filter media of a first filter and passing the liquid the other one of radially inward and radially outward through a second filter media of a second filter.

### FIELD

This disclosure generally relates a filter unit. More particularly, this disclosure relates to filter units configured to filter a liquid.

### BACKGROUND

Filters can be employed in semiconductor manufacturing to remove contaminants from a fluid. A fluid (e.g., liquid, water, or the like) is directed through a filter. The filter can be configured to remove contaminants from the liquid as the liquid passes through the filter. Contaminants can include, for example, solid particles, liquid impurities, and dissolved chemical species.

### SUMMARY

In an embodiment, a filter unit for filtering liquid includes a housing, a first filter, a second filter, and a fluid flow path. The housing includes an inlet and an outlet. The first filter is disposed in the housing and includes a first filter media. The second filter is disposed in the housing and includes a second filter media. The liquid flow path extends from the inlet to the outlet through the first filter media and the second filter media in series. The liquid flow path is configured to direct the liquid one of radially inward and radially outward through the first filter media and to direct the liquid a different one of radially inward and radially outward through the second filter media.

In an embodiment, a method is directed to filtering a liquid within a filter unit. The fluid unit includes a housing with an inlet and an outlet, a first filter disposed in the housing, and a second filter disposed in the housing. The method includes directing the liquid from the inlet of the housing to a first filter media of the first filter disposed and passing the liquid through the first filter media in one of radially inward and radially outward. The method also includes directing the liquid from the first filter to a second filter media of the second filter and passing the liquid through the second filter media in a different one of radially inward and radially outward.

### DRAWINGS

FIG. 1 is a front perspective view of an embodiment of a filter unit.

FIG. 2 is a cross-sectional view of the filter unit in FIG. 1, according to an embodiment.

FIG. 3 is a cross-sectional view of an embodiment of a filter unit.

FIG. 4 is a block flow diagram of an embodiment of a method of filtering a liquid within a filter unit.

Like numbers represent like features.

### DETAILED DESCRIPTION

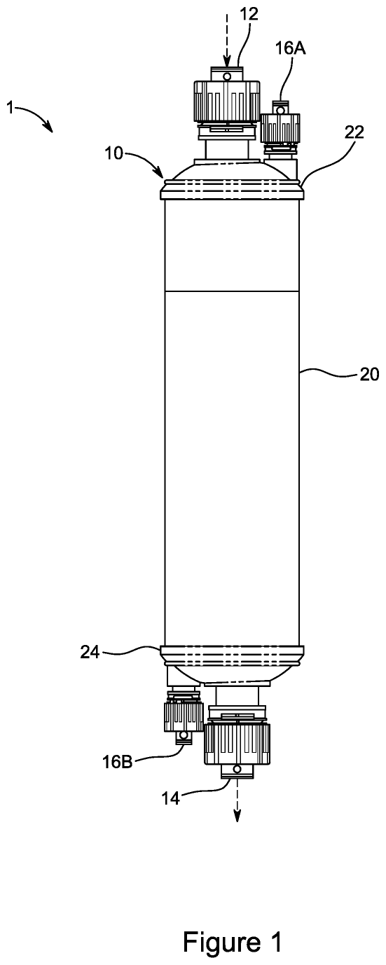

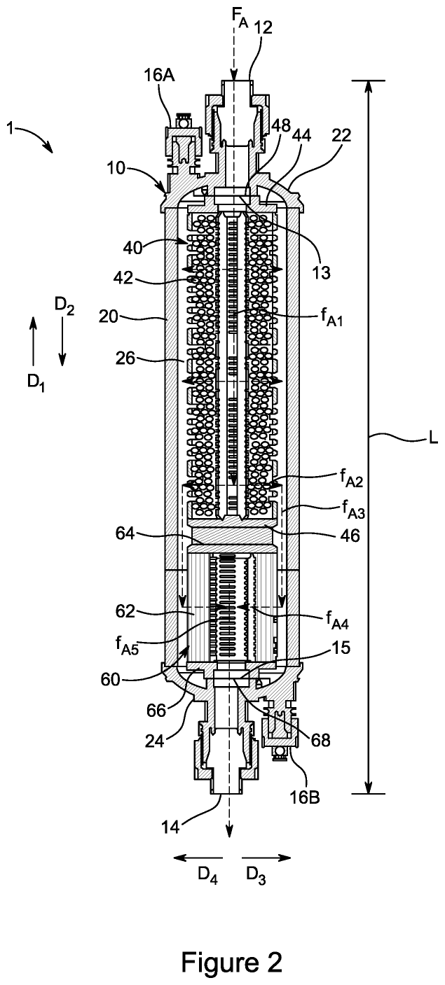

FIG. 1 shows a side perspective view of an embodiment of a filter unit 1. The filter unit 1 is configured to filter a liquid. The liquid is filtered as it passes through the filter unit 1. The flow into and out of the filter unit 1 is indicated in dashed arrows in FIG. 1. The filter unit 1 includes a housing 10 containing filters 40, 60 (shown in FIG. 2) that may be vertically arranged with respect to each other. In some embodiments, the filter unit 1 is a removable filter unit 1 that is configured to be removed and replaced after removing a particular amount of containment(s). In an embodiment, the filter unit 1 can be configured to be installed into a filter manifold (not shown). For example, the filter manifold can include an inlet tube/pipe (not shown) and an outlet tube/pipe (not shown) that connect to the filter unit 1 and supply fluid through the filter unit 1.

As shown in FIG. 1, the housing 10 includes an inlet 12 and an outlet 14. The inlet 12 and the outlet 14 are formed in opposite ends of the housing 10. Liquid (to be filtered) enters the filter unit 10 through the inlet 12. The liquid is filtered within the housing 10 and the filtered liquid is then discharged from the filter unit 1 through the outlet 14. The filter unit 1 is configured to filter a liquid used in semiconductor manufacturing. For example, in some embodiments the filter unit 1 is configured to filter liquids used in photolithography and/or wet etch and clean. The liquid filtered by the filter unit 1 may include one or more acids, bases, oxidizers, and/or reducers or any combinations thereof. For example, the liquid may be water (e.g., deionized water), HCl, HNO₃, isopropyl alcohol, or the like. The housing 10 can also include one or more vents 16A, 16B for allowing discharge of gas from the filter unit 1. For example, each vent(s) 16A, 16B is configured to allow gas that enters with the liquid (e.g., bubbles, etc.) to be vented from the housing 10.

In the illustrated embodiment, the housing 10 includes a tubular body 20, a first end cap 22, and a second end 24. The first end cap 22 and the second end cap 24 are affixed to opposite ends of the tubular body 20. The housing 10 may be assembled mechanically and/or via bonding. As shown in the illustrated embodiment, the housing 10 can be assembled via bonding (e.g., the first end cap 22 and the second end cap 24 are each thermally bonded to the tubular body 20). For example, each of the end caps 22, 24 may be bonded (e.g., thermally bonded, adhesive bonded, etc.) to the tubular body 20. In an embodiment, the housing 10 may be mechanically assembled (e.g., the end caps 22, 24 each mechanically attached to the tubular body 20). For example, the end caps 22, 24 and the tubular body 24 may be mechanically affixed together configured via a snap fit, via lock and key mechanism, or the like. In such embodiments, the housing 10 may include seal(s) (not shown) to provide sealing each of the end caps 22, 24 and the tubular body 20.

It should be appreciated that a tubular shape has an axis that extends along the length of the tubular shape, and that axial refers to a direction extending parallel to the axis and radial refers to a direction that extends perpendicular to the axis (e.g., along a radius/width of the tubular shape) and towards the axis (inward) or away from the axis (outward). The inlet 12 and the outlet 14 are formed in the end caps 22, 24 of the housing 10. For example, as shown in FIG. 1, the inlet 12 is formed in the first end cap 22 and outlet 14 is formed in the second end cap 24 of the housing 10.

FIG. 2 is a cross-sectional view of the filter unit 1. For example, the cross-section of the view in FIG. 2 a vertical cross section of the filter unit 1 in FIG. 1 that bisects the filter unit 1. As shown in FIG. 2, the filter unit 1 includes the housing 10, a first filter 40, and a second filter 60. The housing 10 has an enclosed internal volume 26. The filters 40, 60 are disposed in the housing 10. As shown in FIG. 2, the filters 40, 60 are disposed within the internal volume 26 of the housing 10. The filter unit 1 has a liquid flow path F_{A} through which the liquid flows through the filter unit 1. The liquid flow path F_{A} extends from the inlet 12 to the outlet 14 through the first filter 40 and the second filter 60 in series. The liquid is filtered by the filters 40, 60 as it flows through the liquid flow path F_{A}.

As shown in FIG. 2, the first filter 40 includes a first filter media 42, a first axial end 44 and a second axial end 46. The first axial end 44 and the second axial end 46 are opposite ends of the first filter 40. The first filter media 42 extends along an axial direction of the filter 40 (e.g., direction D₁, direction D₂) between the first axial end 44 and the second axial end 46 of the first filter 40. The first filter media 42 can have a tubular shape within the first filter 40. In the illustrated embodiment, the first filter 40 includes an axial inlet 48 and the first filter media 42 forms a radial outlet of the first filter 40. For example, liquid enters the first filter 40 through its axial inlet 48 and is discharged from the first filter 40 (after being filtered) from its first filter media 42.

The first axial end 44 of the first filter 40 is affixed to the housing 10. The first axial end 44 of the first filter 40 can be bonded or mechanically affixed to the housing 10. In particular, the first axial end 44 is affixed to the first end cap 22 of the housing 10. In the illustrated embodiment, the first axial end 44 is bonded (e.g., thermally bonded, adhesive bonded) to the first end cap 22 of the housing 10. In an embodiment, the first axial end 44 may be mechanically affixed to the housing 10 via a snap fit, threads (e.g., the first axial end 44 having threads that screw into the first end cap 22), or the like. In the illustrated embodiment, the first axial end 44 of the first filter 40 is disposed over the opening 13 in the housing 10 for the inlet 12. The liquid flows from the opening 13 of the inlet 12 into the first filter 40 through its axial inlet 48. The first axial end 44 of the first filter 40 entirely covers the opening 13 for the inlet 12 such as the liquid flowing through the inlet 12 into the housing 10 is forced to flow into the first filter 20. The liquid then flows through the filter media 42 and is discharged from the first filter 40 into the open space in internal volume 26 of the housing 10. For example, the liquid enters the first filter 40 through the axial inlet 48 in an axial direction D₂ and is radially discharged from the first filter 40 (e.g., in radial direction D₃ of the first filter 40, in radial direction D₄ of the first filter, in a radial direction extending directing into the page in FIG. 2, in a radial direction extending directly out of the page in FIG. 2, etc.). For example, as shown in FIG. 2, the liquid is discharge in multiple radial directions (e.g., radial direction D₃, opposite radial direction D₄) from the first filter 40. Within the internal volume 26 of the housing 10, the liquid then flows in the axial direction D₂ of the housing 10 from the filter media 42 of the first filter 40 to the filter media 62 of the second filter 60.

As shown in FIG. 2, the second filter 60 includes a filter media 62, a first axial end 64, and a second axial end 66. The first axial end 64 and the second axial end 66 are opposite ends of the second filter 60. The second filter media 62 extends along an axial direction of the filter 60 (e.g., axial direction D₁, axial direction D₂) between the first axial end 64 and the second axial end 66 of the second filter 60. The second filter media 62 can have a tubular shape within the second filter 60. In the illustrated embodiment, the second filter 60 also includes an axial outlet 68 that is formed in the first axial end 64 of the second filter 60. The second filter media 62 can form the radial inlet of the second filter 60 as shown in FIG. 2. For example, liquid radially enters the second filter 60 through its second filter media 62 and is axially discharged from the second filter 60 (after being filtered) from its axial outlet 68.

The first axial end 64 of the second filter 60 is affixed to the housing 10. The first axial end 64 of the first filter 40 can be bonded or mechanically affixed to the housing 10. In particular, the first axial end 64 of the second filter 60 is affixed to the second end cap 24 of the housing 10. In the illustrated embodiment, the first axial end 64 is bonded (e.g., thermally bonded, adhesive bonded, etc.) to the first end cap 24 of the housing 10. In an embodiment, the first axial end 64 may be mechanically affixed to the housing 10 via a snap fit, threads (e.g., first axial end 64 screwing into threads in the inner surface 26), or the like. The first axial end 64 of the second filter 60 is disposed over the opening 15 in the housing 10 for the outlet 16. In the illustrated embodiment, the first axial end 64 forms a sealed connection with of the housing 10 such that the liquid in the open internal volume 24 is forced to flow through the second filter 60 to exit the housing 10 and the filter unit 1.

As shown in FIG. 2, the first axial end 64 of the second filter 60 is disposed over the opening 15 in the housing 10 for the inlet 14. The first axial end 64 of the second filter 60 entirely covers the opening 16 in the housing 10 for the outlet 16. The liquid that flows into the second filter 60 is discharged from the second filter 60 through its axial outlet 68 into the outlet 14 in the housing 10. The liquid flows from the axial outlet 68 of the second filter 60 into the outlet 14 of the housing 10. The liquid then flowing out of the filter unit 1 from the outlet 14 of the housing 10. The filter media 62 can form the radial inlet of the second filter 60. The liquid (discharged from the first filter 40 flowing through internal volume 26) radially enters the second filter 60 through filter media 62 (e.g., in direction D₃ into the second filter 60, in direction D₄ into the second filter 60, etc.) and is axially discharged from the second filter 60 (e.g., in direction D₂).

As shown in FIG. 2, the first axial end 44 of the first filter 40 and the first axial end 64 of the second filter 60 are bonded to opposite ends of the housing 10. Within the housing 10, the filters 40, 60 are disposed end to end along the length L of the housing 10. For example, the filters 40, 60 are disposed consecutively along the length L of then housing 10. The filters 40, 60 are provided with their closest axial ends 46, 64 overlapping in the axial direction of the housing 10 (e.g., direction D₁, direction D₂). In the illustrated embodiment, the second axial end 46 of the first filter 40 is affixed to the first axial end 64 of the second filter 60. In an embodiment, the first filter 40 and the second filter 60 may be formed as a single integral part. For example, the main frame of the first filter 40 and the main frame of the second filter 60 can be formed as a single integral part and the first filter media 42 and the second filter media 62 are then provided (e.g. attached and/or filled with) on the single integral part. In an embodiment, the second axial end 46 of the first filter 40 may be spaced apart from the first axial end 64 of the second filter 60. For example, in such an embodiment, a space may be provided between the second axial end 46 of the first filter 40 and the first axial end 64 of the second filter 60.

The liquid flow path F_{A} extends through the housing 10 from the inlet 12 to the outlet 14. The liquid flow path is configured to extend through the filters 40, 60 in series. The liquid flow path F_{A} extends from the inlet 12 to the outlet 14 through the first filter media 42 and the second filter media 62 in series. The liquid is filtered by the first filter media 42 and then filtered by the second filter media 62 (e.g., the liquid filtered by the first filter media 42 is filtered further by the second filter media 62). The liquid flow path F_{A} is formed of a plurality of portions f_{A1}, f_{A2} f_{A3}, f_{A4}, f_{A5}. In an embodiment, the portions f_{A1}, f_{A2} f_{A3}, f_{A4}, f_{A5} of the flow path are connected to each other consecutively. For example, second portion f_{A2} connects the first portion f_{A1} to the third portion f_{A3} (e.g., the second portion f_{A2} extending from an end of the first portion f_{A1} to a beginning of the third portion f_{A3}).

A first portion f_{A1} of the liquid flow path F_{A} extends through the first filter 40 along the axis of the first filter 40. For example, the first portion f_{A1} extends from the inlet 12 of the housing 10 through the axial inlet 48 into first filter 40. A first portion f_{A1} of the liquid flow path F_{A} directs the liquid (to be filtered) from the inlet 12 of the housing 10 into the first filter 40. The second portion f_{A2} of the liquid flow path F_{A} extends radially outward through the first filter media 42. For example, the second portion f_{A2} extends out of the first filter 40 through the first filter media 42 into the internal volume 26 of the housing 10. The second portion f_{A2} is configured to direct the liquid to flow radially outward from the first filter media 42 of the first filter 40 (e.g., in direction D₃ extending out of the first filter 40, in direction D₃ extending out of the filter 40, in the direction extending directly into the page, in the direction extending directly out from the page, etc.). The liquid is filtered as it passes through the first filter media 42. For example, in the illustrated embodiment, the liquid is filtered as it passes through the resin beads of the first filter media 42. The liquid filtered by the first filter media 42 is radially discharged from the first filter into the internal volume 26 of the housing 10.

A third portion f_{A3} of the liquid flow path F_{A} extends along an exterior of the first filter 40 and an exterior of the second filter 60. Third portion f_{A3} can extend through the internal volume 26 external to both the first filter 40 and the second filter 60. As shown in FIG. 2, the third portion f_{A3} extends in the axial direction D₂. For example, the third portion f_{A3} extends in the axial direction D₂ past the second axial end 46 of the first filter 40 and the first axial end 64 of the second filter 60. As shown in FIG. 2, the third portion f_{A3} can extend in the same direction (e.g., direction D₂) as the first portion and the fifth portion f_{A5}.

A fourth portion f_{A4} of the liquid flow path F_{A} extends radially inward through the second filter media 62. The fourth portion f_{A4} extends from outside the second filter 60 (e.g., from the internal volume 26) into the second filter 60. The fourth portion f_{A4} extends radially inward into the second filter 60 (e.g., in direction D₃ extending into the second filter 60, in direction D₃ extending into the second filter 60, in a direction directly into the page in FIG. 2, in a direction directly out from the page in FIG. 2, etc.). As shown in FIG. 2, the second portion f_{A2} and the fourth portion f_{A4} extend in opposite directions D₃, D₄.

A fifth portion f_{A5} of the liquid flow path F_{A} extends through the second filter 60. The fifth portion f_{A5} extends in the axial direction D₂. For example, the fifth portion f_{A5} extends from within the second filter 60 through the axial outlet 68 to the outlet 14 of the housing 10. The fifth portion f_{A5} of the liquid flow path F_{A} directs the filtered liquid from the second filter 60 to the outlet 14 of the housing 10. The fifth portion f_{A5} extends axially through the second filter 60 (e.g., direction D₂). For example, the fifth portion f_{A5} can extend in the same axial direction D₂ as first portion f_{A1}. The fifth portion f_{A5} is configured to direct the liquid (after being filtered by the second filtering media 62) from the second filter 60 to the outlet 14 of the housing 10. The filtered liquid is then discharged from the filter unit 1 from the outlet 14 of the housing 10. The liquid (to be filtered) enters the filter unit 1 through the inlet 12, is passed through the filters 40, 60, and their filter medias 42, 62 in series, and then the filtered liquid is discharged from the outlet 14.

The filters 40, 60 of the filter unit 1 may be configured to filter contaminants that include, for example, solid particulates, liquid impurities (e.g., organics, etc.), and/or dissolved chemical species (e.g., dissolved metals, ions, etc.). The filter media 42, 62 used in the filter unit 1 can be selected such that the filter unit 1 removes the desired contaminant(s) from the liquid.

As shown in FIG. 2, the first filter media 42 and the second filter media 62 are different types of filter media. In such an embodiment, the first filter media 42 provides a first type of contaminant filtering and the second filter media 62 provides a second type of contaminant filtering. For example, the first filter media 42 may provide metal ion filtering and the second filter media 62 may provide particle filtering. In an embodiment, the first filter media 42 may generate particles (e.g., resin beads, etc.) during use, and the second filter media 62 may provide particle filtering that captures the particles generated by the first filter media 42. This can advantageously allow for a single filter unit to provide multiple types of contaminant filtering in a single unit and/or to employ types of filter media that generate particles.

In an embodiment, the first filter media 42 and the second filter media 62 may be the same type of filter media. In such an embodiment, the first filter media 42 and the second filter media 62 provide the same type of contaminant filtering. The first filter media 42 can be configured to remove a contaminant to a first concentration in the liquid and the second filter media 62 can be configured to further remove the contaminant to a second lower concentration in the liquid. This can advantageously allow for the filter unit to provide high load filtration for liquids that contain high amounts of a contaminant.

In the illustrated embodiment, the first filter media 42 is resin beads. The resin beads are in the form of a packed bed. In an embodiment, the resin beads can be one type (single component) or multiple types (multi-component). In the illustrated embodiment, the second filter media 62 is a membrane. A membrane filter in an embodiment can have single layer or multiple layers (e.g., a fabric layer, a polymer coating layer, etc.). In an embodiment, the first filter media 42 and the second filter media 62 may each be selected from one of a membrane, resin beads, hollow fibers, depth fibers, a sponge based media, or a combination thereof. For example, a membrane can be configured to filter organics, metals, particles, ions (e.g., cations and anions), etc. from liquid. For example, resin beads can be configured to filter metals organics (e.g., resin beads in the form of an activated carbon bed, etc.). For example, depth fibers are generally configured for use in high contaminant load applications.

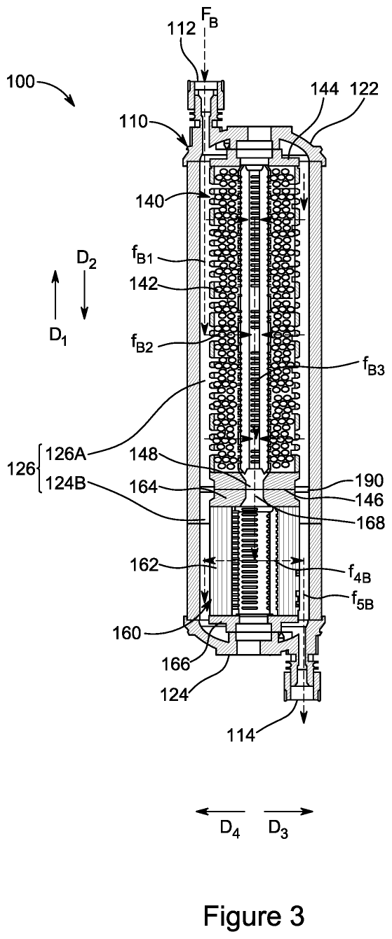

FIG. 3 is a cross-sectional view of another embodiment of a filter unit 100. The filter unit 100 generally has similar features to the filter unit 1 in FIGS. 1 and 2, except as discussed below. For example, the filter unit 100 includes a housing 110 with an inlet 112 and outlet 114, a first filter 140 and a second filter 160 disposed within the housing 110, and a liquid flow path F_{B} extending from the inlet 112 to the outlet 114 through the first filter 140 and the second filter 160 in series, as similarly discussed above for the filter unit 1 in FIGS. 1 and 2. For example, the first filter 140 includes a first axial end 144 affixed to a first end cap 122 of the housing 110, and the second filter 140 includes a second axial end 146 affixed to an opposite second end cap 124 of the housing 110. The first filter 140 includes a first filter media 142 and the second filter 160 includes a second filter media 162 with features as similarly described for the filter media 42, 62 in FIGS. 2 and 3. In an embodiment, the housing 110 may include one or more vents for venting gas as discussed for the housing 10 in FIGS. 1 and 2 (e.g., vent 16A, vent 16B)

As shown in FIG. 3, the first filter 140 includes an axial outlet 148 formed in the second axial end 146 of the first filter 140. The first filter media 142 is configured to be the radial inlet of the first filter 140. The first filter 140 configured to discharge the liquid filtered by the first filter media 142 (e.g., the fluid flowing into the first filter 140) through its axial outlet 148. The second filter 160 includes an axial inlet 168 formed in the first axial end 164 of the second filter 160. The second filter media 162 is configured to be the radial outlet of the second filter 160. The second axial end 146 of the first filter 140 is affixed to the first axial end 164 of the second filter 160 such that the axial outlet 148 of the first filter 160 fluidly connects to the axial inlet 168 of the second filter 160. For example, the second axial end 146 of the first filter 140 can be bonded (e.g., thermally bonded) to the first axial end 164 of the second filter 160. The axial ends 146, 164 are connected such that the axial outlet 148 of the first filter 140 overlaps with the axial inlet 168 of the second filter. In an embodiment, the first filter 140 and the second filter 160 may be formed as a single integral part. For example, the main frame of the first filter 140 and the main frame of the second filter 160 can be formed as a single integral part and the first filter media 142 and the second filter media 162 are then provided (e.g. attached and/or filled with) on the single integral part.

As shown in FIG. 3, the interior volume 126 of the housing 110 includes an upper interior volume 126A and a lower interior volume 126B. The filter unit 100 includes a divider 190 that separates the upper interior volume 126A from the lower interior volume 126B. The inlet 112 of the housing 110 connects to the upper interior volume 126A (e.g., directs its unfiltered liquid into the upper interior volume 126A) and the outlet 114 connects from the lower interior volume 124B. As illustrated by the liquid flow path F_{B}, the configuration of the filter unit 100 forces the liquid to pass through the filters 140, 160 to flow from the upper interior volume 126A to the lower interior volume 126B (e.g., to flow from the inlet 112 to the outlet 114 within the housing 110). For example, the upper interior volume 126A is connected to the lower interior volume 126B through the connected axial outlet 148 and axial inlet 168 of the filters 140, 160.

The first filter media 142 is the radial inlet of the first filter 140, and the second filter media 162 is the radial outlet of the second filter 160. Liquid radially enters the first filter 140 through its first filter media 142 (e.g., in direction D₃ extending into the first filter 140, and in direction D₄ extending into the first filter 140, etc.) and is discharged from the first filter 140 (after being filtered) from its axial outlet 148 in an axial direction of the first filter 140 (e.g., direction D₂). Liquid flows into the second filter 160 (from the first filter 140) through its axial inlet 168 in the axial direction of the second filter 160 (e.g., in direction D₂) and is radially discharged from the second filter 160 from its second filter media 162 (e.g., in direction D₃ extending into the second filter 160, and in direction D₄ extending into the second filter 160, etc.). For example, as shown in FIG. 3, the liquid is discharge in multiple radial directions (e.g., radial direction D₃, opposite radial direction D₄) from the second filter 160. In the illustrated embodiment, the liquid is directed radially inward through the first filter media 142 and is directed radially outward through the second filter media 162.

The liquid flow path F_{B} extends through the housing 110 from the inlet 112 to the outlet 114. The liquid flow path is configured to extend through the filters 140, 160 in series. The liquid flow path F_{B} extends from the inlet 112 to the outlet 114 through the first filter media 142 and the second filter media 162 in series. The liquid is filtered by the first filter media 142 and then filtered by the second filter media 162 (e.g., the liquid filtered by the first filter media 142 is filtered further by the second filter media 162). The liquid flow path F_{B} is formed of a plurality of portions f_{B1}, f_{B2} f_{B3}, f_{B4}, f_{B5}. In an embodiment, the portions f_{B1}, f_{B2} f_{B3}, f_{B4}, f_{B5} of the flow path are connected to each other consecutively. For example, second portion f_{B2} connects the first portion f_{B1} to the third portion f_{B3} (e.g., the second portion f_{B2} extending from an end of the first portion f_{B1} to a beginning of the third portion f_{B3}).

A first portion f_{B1} of the liquid flow path F_{B} extends through the internal volume 126 along the exterior of the first filter 140. The first portion f_{B1} is external to the filters 140, 160 and extends in an axial direction of the housing 110 (e.g., direction D₂). For example, the first portion f_{B1} extends from the inlet 112 of the housing 110 into the upper internal volume 126 external of the filters 140, 160. The first portion f_{B1} of the liquid flow path F_{B} directs the liquid (to be filtered) from the inlet 112 of the housing 110 to the filter media 142 of the first filter.

A second portion f_{B2} of the liquid flow path F_{B} extends radially inward through the first filter media 142. For example, the second portion f_{B2} extends from the internal volume 126 of the housing 110 (e.g., from upper internal volume 126A) through the first filter media 142 into the first filter 124. The second portion f_{B2} is configured to direct the liquid to flow radially inward (e.g., in direction D₃ extending into the first filter 140, and in direction D₄ extending into the first filter 140, etc.) through the first filter media 142. The liquid is filtered as it passes through the first filter media 142 as similarly for the first filter media 42 in FIGS. 2 and 3.

A third portion f_{B3} of the liquid flow path F_{B} extends from the first filter 140 to the second filter 160. The third portion f_{B3} extends through the first filter 140 along the axis of the first filter 140 (e.g., in axial direction D₂) and extends through the second filter 160 along the axis of the second filter 160 (e.g., in axial direction D₂). The third portion f_{B3} extends through the axial outlet 148 of the first filter 140 and the axial inlet 168 of the second filter 160. The third portion f_{B3} is configured to direct the liquid filtered by the first filter media 142 from the first filter 140 into the second filter 160. For example, the liquid flowing in the third portion third portion f_{B3} is discharged from the axial outlet 148 of the first filter 140 into the axial inlet 168 of the second filter 160. As shown in FIG. 3, the third portion f_{B3} can extend in the same direction (e.g. direction D₂) as the first portion f_{B1}.

A fourth portion f_{B4} of the liquid flow path F_{B} extends radially outward through the second filter media 162. The fourth portion f_{A4} extends from inside the second filter 160 into the internal volume 126 (e.g., into the lower internal volume 126B). The fourth portion f_{A4} is configured to direct the liquid within the second filter 160 to flow radially outward (e.g., in direction D₃ extending out of the second filter 160, and in radial direction D₃ extending out of the second filter 160, etc.) through the second filter media 162 into the internal volume 126. As shown in FIG. 3, the second portion f_{B2} and the fourth portion f_{B4} extend in opposite directions D₃, D₄.

A fifth portion f_{B5} of the liquid flow path F_{B} extends through the internal volume 126 along the exterior of the first filter 140. The fifth portion f_{B5} is external to the filters 140, 160 and extends in the axial direction D₂ of the housing 110. For example, the fifth portion f_{B5} extends from the lower internal volume 126B external to the filters 140, 160 to the outlet 114 of the housing 110. The fifth portion f_{B5} directs the liquid (after being filtered by the second filtering media 162) from the second filter 160 to the outlet 114 of the housing 110. As shown in FIG. 3, the fifth portion f_{B5} can extend in the same direction D₂ as the first portion f_{B2} and the third portion f_{B2} of the liquid flow path F_{B}. The filtered liquid is then discharged from the filter unit 100 from the outlet 114 of the housing 110. The liquid (to be filtered) enters the filter unit 101 through the inlet 112, is passed through the filters 140, 142, and their filter medias 142, 162 in series, and then the filtered liquid is discharged from the outlet 114.

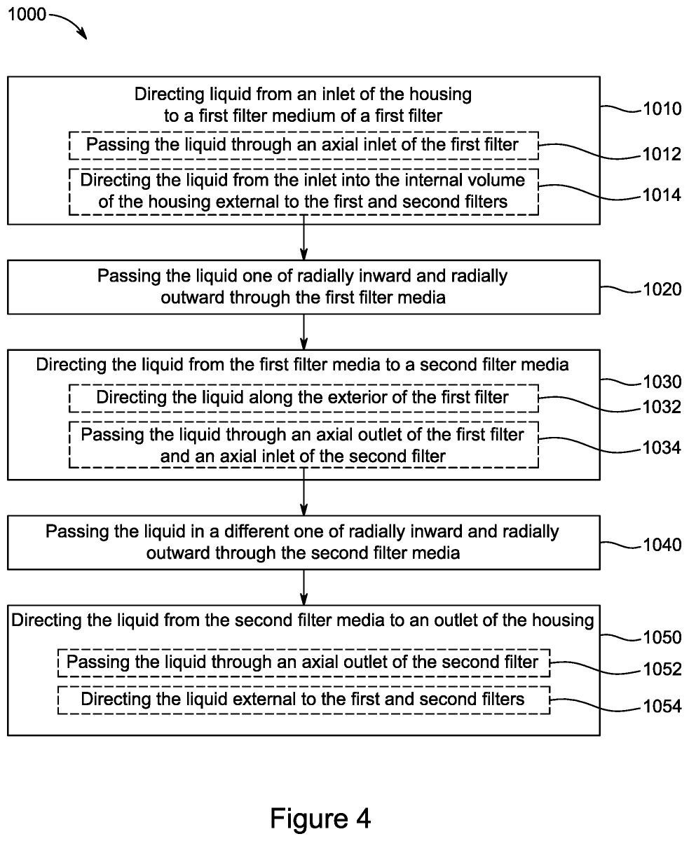

FIG. 4 is a block flow diagram of a method 1000 of filtering a liquid in a filter unit. The method 1000 may be applied to the filter unit 1 of FIGS. 1 and 2 and the filter unit 100 of FIG. 3. The filter unit includes a housing (e.g., housing 10, housing 110) and a first filter (e.g., first filter 40, first filter 140) and a second filter (e.g., second filter 60, second filter 160) disposed in the housing. The method 1000 starts at 1010.

At 1010, the liquid is directed from an inlet (e.g., inlet 12, inlet 112) of the housing to a first filter media of the first filter (e.g., first filter media 42, first filter media 142). In an embodiment, directing the liquid at 1010 can include passing the liquid through an axial inlet of the first filter 1012 (e.g., axial inlet 48). In an embodiment, directing the liquid at 1010 can include directing the liquid from the inlet into the internal volume of the housing (e.g., internal volume 26, internal volume 126) external to the first and second filters 1014. The method 1000 then proceeds to 1020.

At 1020, the liquid is passed one of radially inward and radially outward through the first filter media. In an embodiment, the liquid passes radially outward through the first filter media at 1020 (e.g., second portion f_{A2} of liquid flow path F_{A}). For example, the liquid is directed out of the first filter into the open space of the internal volume of the housing (e.g., open space of the internal volume 24 along the exterior of the first filter 40). In an embodiment, the liquid passes radially inward through the first filter media at 1020 (e.g., second portion f_{B2} of liquid flow path F_{B}). The method 1000 then proceeds to 1030. For example, the liquid is directed from the internal volume into the first filter (e.g., from upper internal space 126A into the first filter 140). The method 1000 then proceeds to 1030.

At 1030, the liquid is directed from the first filter media to a second filter media of the second filter (e.g., second filter media 62, second filter media 162). In an embodiment, the directing of the liquid at 1030 includes directing the liquid through the internal volume of the housing along the exterior of the first filter 1032 (e.g., third portion f_{A3} of liquid flow path F_{A}). In an embodiment, directing the liquid at 1030 can include passing the liquid through an axial outlet of the first filter (e.g., axial outlet 148) and an axial inlet of the second filter 1034 (e.g., axial inlet 168). The method 1000 then proceeds to 1040.

At 1040, the liquid is passed in a different one of radially inward and radially outward through the second filter media. In an embodiment, the liquid is passed radially outward through the first filter media at 1020, and the liquid is passed radially inward through the second filter media at 1040 (e.g., fourth portion f_{A4} of liquid flow path F_{A}). For example, the liquid is directed radially inward from the internal volume of the housing (e.g., the internal volume 24 external to the filters 20, 40) into the second filter through the second filter media. In an embodiment, the liquid is passed radially inward through the first filter media at 1020, and the liquid is passed radially outward through the second filter media at 1040 (e.g., fourth portion f_{B4} of liquid flow path F_{B}). For example, the liquid is directed radially outward through the filter media into the internal volume of the housing (e.g., lower internal volume 126B). In an embodiment, the method 1000 may then also then proceed to 1050.

At 1050, the liquid is directed from the second filter media to an outlet of the housing (e.g., outlet 14, outlet 114). In an embodiment, directing the liquid to the outlet of the housing at 1050 can include passing the liquid through an axial outlet of the second filter 1052 (e.g., axial outlet 68). For example, passing the liquid through the axial outlet at 1052 can include directing the liquid from the axial outlet of the second filter into an opening in the housing for the outlet (e.g., opening 15). In an embodiment, directing the liquid to the outlet of the housing at 1050 can include directing the filtered liquid external to the first and second filters 1054 (e.g., filtered liquid discharged from the second filter media 162 in the lower internal volume 126B). For example, directing the filtered liquid external to the filters at 1054 can include directing the liquid along the exterior of the second filter (e.g., fifth portion f_{B5} of liquid flow path F_{B}).

It should be appreciated that the method 1000 in an embodiment may be modified to include features as described above with respect to the filter unit 1 in FIGS. 1 and 2 and/or features as described above with respect to the filter unit 100 in FIG. 3.

### Aspects:

Any of Aspects 1-11 can be combined with any of aspects 12-18.

Aspect 1. A filter unit for filtering liquid, comprising: a housing having an inlet and an outlet; a first filter disposed in the housing and including a first filter media; a second filter disposed in the housing and including a second filter media; and a liquid flow path extending from the inlet to the outlet through the first filter media and the second filter media in series, the liquid flow path configured to direct the liquid one of radially inward and radially outward through the first filter media and to direct the liquid a different one of radially inward and radially outward through the second filter media.

Aspect 2. The filter unit of Aspect 1, wherein the first filter and the second filter disposed end to end along a length of the housing.

Aspect 3. The filter unit of any one of Aspects 1 and 2, wherein the liquid flow path is configured to direct the liquid radially outward through the first filter media and to direct the liquid radially inward through the second filter media, the first filter media being a radial outlet of the first filter, and the second filter media being a radial inlet of the second filter.

Aspect 4. The filter unit of any one of Aspects 1 and 2, wherein the liquid flow path is configured to direct the liquid radially inward through the first filter media and to direct the liquid radially outward through the second filter media, the first filter media being a radial inlet of the first filter, and the second filter media being a radial outlet of the second filter.

Aspect 5. The filter unit of any one of Aspects 1-4, wherein the housing has a first end cap and a second end cap, a second end of the first filter affixed to the first end cap, and a second end cap of the housing affixed to a second end of the second filter.

Aspect 6. The filter unit of Aspect 5, wherein the first end cap includes the inlet of the housing and the second end cap includes the outlet of the housing.

Aspect 7. The filter unit of any one of Aspects 1-6, wherein radially inward and radially outward are opposite directions.

Aspect 8. The filter unit of any one of Aspects 1-7, wherein the flow path includes, in order: a first portion extending through the first filter in an axial direction, a second portion extending through the first filter media in the one of radially inward and radially outward, a third portion extending one of along an exterior of the first filter in the axial direction and through an axial inlet of the first filter and axial outlet of the second filter, a fourth portion extending through the second filter media in the different one of radially inward and radially outward through the second filter media, and a fifth portion extending through the second filter in the axial direction.

Aspect 9. The filter unit of any one of Aspects 1-8, wherein the first filter media and the second filter media are the same type of filter media.

Aspect 10. The filter unit of any one of Aspects 1-8, wherein the first filter media and the second filter media are different types of filter media.

Aspect 11. The filter unit of any one of Aspects 1-8, wherein the first filter media and the second filter media are each selected from a membrane, resin beads, hollow fibers, depth fibers, a sponge based media, or a combination thereof.

Aspect 12. A method of filtering a liquid within a filter unit, the filter unit including a housing with an inlet and an outlet, the method comprising: directing the liquid from an inlet of the housing to a first filter media of a first filter disposed in the housing; passing the liquid through the first filter media in one of radially inward and radially outward; directing the liquid from the first filter to a second filter media of a second filter disposed in the housing; and passing the liquid through the second filter media in a different one of radially inward and radially outward.

Aspect 13. The method of Aspect 12, further comprising: directing the liquid from the second filter media to an outlet of the housing.

Aspect 14. The method of any one of Aspects 12 and 13, wherein the directing of the liquid from the second filter media to an outlet of the housing includes passing the liquid through an axial outlet of the second filter.

Aspect 15. The method of any one of Aspects 12 and 13, wherein the directing of the liquid from the second filter media to an outlet of the housing includes directing the liquid external to the first filter and the second filter to the outlet.

Aspect 16. The method of any one of Aspects 12, 13, and 14 wherein the directing of the liquid from the inlet of the housing to the first filter media of the first filter includes passing the liquid through an axial inlet of the first filter.

Aspect 17. The method of any one of Aspects 12, 13, and 15, wherein the first filter and the second filter are disposed in an internal volume of the housing, the directing of the directing of the liquid from the inlet of the housing to the first filter media of the first filter includes directing the liquid from the inlet into the interior volume of the housing external to the first filter and the second filter.

Aspect 18. The method of any one of Aspects 12-17, wherein the first filter media and the second filter media are each selected from a membrane, resin beads, hollow fibers, depth fibers, a sponge based media, or a combination thereof.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A filter unit for filtering liquid, comprising:
a housing having an inlet and an outlet;
a first filter disposed in the housing and including a first filter media;
a second filter disposed in the housing and including a second filter media; and
a liquid flow path extending from the inlet to the outlet through the first filter media and the second filter media in series, the liquid flow path configured to direct the liquid one of radially inward and radially outward through the first filter media and to direct the liquid a different one of radially inward and radially outward through the second filter media.

2. The filter unit of claim 1, wherein the first filter and the second filter disposed end to end along a length of the housing.

3. The filter unit of claim 1, wherein the liquid flow path is configured to direct the liquid radially outward through the first filter media and to direct the liquid radially inward through the second filter media, the first filter media being a radial outlet of the first filter, and the second filter media being a radial inlet of the second filter.

4. The filter unit of claim 1, wherein the liquid flow path is configured to direct the liquid radially inward through the first filter media and to direct the liquid radially outward through the second filter media, the first filter media being a radial inlet of the first filter, and the second filter media being a radial outlet of the second filter.

5. The filter unit of claim 1, wherein the housing has a first end cap and a second end cap, a second end of the first filter affixed to the first end cap, and a second end cap of the housing affixed to a second end of the second filter.

6. The filter unit of claim 5, wherein the first end cap includes the inlet of the housing and the second end cap includes the outlet of the housing.

7. The filter unit of claim 1, wherein radially inward and radially outward are opposite directions.

8. The filter unit of claim 1, wherein the flow path includes, in order:
a first portion extending through the first filter in an axial direction,
a second portion extending through the first filter media in the one of radially inward and radially outward,
a third portion extending one of along an exterior of the first filter in the axial direction and through an axial inlet of the first filter and axial outlet of the second filter,
a fourth portion extending through the second filter media in the different one of radially inward and radially outward through the second filter media, and
a fifth portion extending through the second filter in the axial direction.

9. The filter unit of claim 1, wherein the first filter media and the second filter media are the same type of filter media.

10. The filter unit of claim 1, wherein the first filter media and the second filter media are different types of filter media.

11. The filter unit of claim 1, wherein the first filter media and the second filter media are each selected from a membrane, resin beads, hollow fibers, depth fibers, a sponge based media, or a combination thereof.

12. A method of filtering a liquid within a filter unit, the filter unit including a housing with an inlet and an outlet, the method comprising:
directing the liquid from an inlet of the housing to a first filter media of a first filter disposed in the housing;
passing the liquid through the first filter media in one of radially inward and radially outward;
directing the liquid from the first filter to a second filter media of a second filter disposed in the housing; and
passing the liquid through the second filter media in a different one of radially inward and radially outward.

13. The method of claim 12, further comprising:
directing the liquid from the second filter media to an outlet of the housing.

14. The method of claim 13, wherein the directing of the liquid from the second filter media to an outlet of the housing includes passing the liquid through an axial outlet of the second filter.

15. The method of claim 13, wherein the directing of the liquid from the second filter media to an outlet of the housing includes directing the liquid external to the first filter and the second filter to the outlet.

16. The method of claim 12, wherein the directing of the liquid from the inlet of the housing to the first filter media of the first filter includes passing the liquid through an axial inlet of the first filter.

17. The method of claim 12, wherein the first filter and the second filter are disposed in an internal volume of the housing, the directing of the liquid from the inlet of the housing to the first filter media of the first filter includes directing the liquid from the inlet into the interior volume of the housing external to the first filter and the second filter.

18. The method of claim 12, wherein the first filter media and the second filter media are each selected from a membrane, resin beads, hollow fibers, depth fibers, a sponge-based media, or a combination thereof.
